(19) United States
(12) Patent Application Publication
(10) Pub. No.: US 2023/0110031 A1
(43) Pub. Date: Apr. 13, 2023

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Osamu NAGASAKA, Toyota-shi (JP); Norihiko OSHIO, Nagoya-shi (JP); Kosuke SAKAKIBARA, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 17/934,883

(22) Filed: Sep. 23, 2022

(30) Foreign Application Priority Data
Oct. 7, 2021 (JP) 2021-165662

(51) Int. Cl. G06Q 30/06; G06Q 10/00

(52) U.S. Cl. CPC G06Q 30/0637; G06Q 10/20

(57) ABSTRACT

An information processing apparatus for accepting an order for a product including a vehicle part determines, in relation to a target vehicle, whether to accept an order for a first product at least including a sticker displaying that any of one or more of vehicle parts is upgraded, based on a record of order for a product at least including the sticker.

### CROSS REFERENCE TO THE RELATED APPLICATION

This application claims the benefit of Japanese Patent Application No. 2021-165662, filed on Oct. 7, 2021, which is hereby incorporated by reference herein in its entirety.

### BACKGROUND

### Technical Field

The present disclosure relates to an order placement system for vehicle parts.

### Description of the Related Art

Evaluation of a used vehicle is known to change depending on options, mounted equipment and the like. In this regard, Patent Literature 1 discloses a system that registers a history (a part replacement history, a maintenance history, and the like) of a vehicle that is sold as a used vehicle, in a server apparatus, and that provides the same to consumers.
[Patent Literature 1] Japanese Patent Laid-Open No 2005-346170

### SUMMARY

The present disclosure is aimed at appropriately managing a certificate about a vehicle part.

An information processing apparatus according to a first aspect of the present disclosure is an information processing apparatus for accepting an order for a product including a vehicle part, the information processing apparatus including: a controller configured to determine, in relation to a target vehicle, whether to accept an order for a first product at least including a sticker displaying that any of one or more of vehicle parts is upgraded, based on a record of order for a product at least including the sticker.

An information processing method according to a second aspect of the present disclosure is an information processing method performed by a computer configured to accept an order for a product including a vehicle part, the information processing method including: determining, in relation to a target vehicle, whether to accept an order for a first product at least including a sticker displaying that any of one or more of vehicle parts is upgraded, based on a record of order for a product at least including the sticker.

An information processing apparatus according to a third aspect of the present disclosure is an information processing apparatus for accepting an order for a product including a vehicle part, the information processing apparatus including: a controller configured to determine, in relation to a target vehicle, whether to accept an order for a product at least including a sticker displaying that any of one or more of vehicle parts is upgraded, based on a record of upgrade of the predetermined vehicle part.

Furthermore, another aspect of the present disclosure is a program for causing a computer to perform the information processing method described above, or a non-transitory computer-readable storage medium storing the program.

According to the present disclosure, a certificate about a vehicle part may be appropriately managed.

### BRIEF DESCRIPTION OF THE DRAWINGS

FIG. 1 is a diagram describing an outline of an order placement system;

FIG. 2A to FIG. 2C are each a diagram illustrating an example of a sticker to be attached to a vehicle body;

FIG. 3 is a diagram describing a location where the sticker is to be attached;

FIG. 4 is a diagram illustrating structural elements of an order management server 200;

FIG. 5 is a diagram describing types of vehicle parts supplied by a vehicle manufacturer;

FIG. 6 is an example of a part list stored in a storage unit;

FIG. 7 is an example of order record data stored in the storage unit;

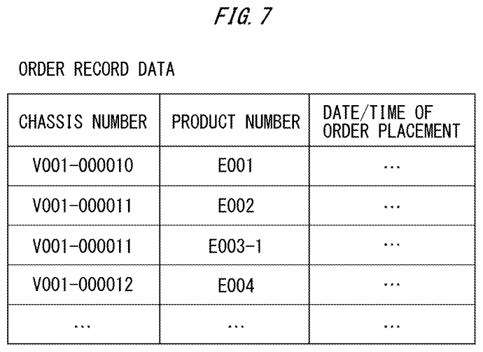

FIG. 8 is an example illustrating a system configuration of a user terminal 100;

FIG. 9 is a sequence diagram illustrating processes that are performed by the user terminal 100 and the order management server 200;

FIG. 10 is an example of a screen including a search form;

FIG. 11 is a flowchart describing processes that are performed in step S12;

FIG. 12 is a flowchart describing a process that is performed in step S24;

FIG. 13 is an example of a screen for outputting a list of products that can be ordered;

FIG. 14 is a diagram describing types of vehicle parts supplied in a second embodiment;

FIG. 15 is an example of the part list in the second embodiment; and

FIG. 16 is a flowchart of processes that are performed in step S24 in the second embodiment.

### DESCRIPTION OF THE EMBODIMENTS

There are techniques for replacing or updating parts (vehicle parts) of a vehicle in an ex-post manner. For example, fabric seats may be replaced with leather ones, or a steering wheel may be replaced with one with a built-in heater. Furthermore, by updating software of an in-vehicle computer, functions not installed at a time of sale of a new vehicle (such as functions related to safety and traveling support functions) may be added.

In the present disclosure, enhancing the function or quality of a vehicle part through replacement of the part or update of software will be referred to as “upgrade”.

The value of a used vehicle is increased by upgrading vehicle parts. Accordingly, that upgrade was performed by an authorized program is desirably certified by a vehicle manufacturer. For example, by attaching a certificate to a maintenance note of a vehicle, it can be certified at the time of sale of the vehicle that upgrade was performed with a genuine part.

Certification may also be performed using a sticker. For example, when a sticker displaying that any of vehicle parts of a vehicle is upgraded is attached to a vehicle body, whether upgrade is performed or not may be grasped at a glance.

However, in the case where such a sticker is supplied by a vehicle manufacturer, the sticker may circulate in a manner unrelated to the vehicle. For example, in the case where such a sticker is sold by itself, the sticker is possibly purchased and used with intention of wrongdoing. For example, a vehicle whose vehicle part is not upgraded is possibly sold as a used vehicle with a sticker displaying that a vehicle part is upgraded attached thereto. When such a case occurs, the sticker itself is discredited.

An information processing apparatus according to the present disclosure solves such a problem by associating with each other a vehicle and a record of order for the sticker.

An information processing apparatus according to a first mode of the present disclosure is an information processing apparatus for accepting an order for a product including a vehicle part, the information processing apparatus including a controller configured to determine, in relation to a target vehicle, whether to accept an order for a first product at least including a sticker displaying that any of one or more of vehicle parts is upgraded, based on a record of order for a product at least including the sticker.

The sticker according to the present disclosure is a label displaying that any of a plurality of vehicle parts of a vehicle is upgraded. The sticker is attached at any position (such as a center pillar) on a vehicle body. Only one sticker is attached to each vehicle. That is, a vehicle to which the sticker is attached is a vehicle that is upgraded in some way.

Additionally, the sticker may be a laminated piece of paper, a metal plate or the like.

The controller determines whether to newly accept an order for a product including the sticker, based on a record of order for a product at least including such a sticker. For example, in relation to a predetermined vehicle, in the case where a sticker was ordered in past, a new order is restricted such that the same sticker is not newly supplied. Supply of a plurality of stickers to a same vehicle may thus be prevented.

Additionally, “a product including a sticker” may be a product including only the sticker, or may be a product (a product set) that is a set of a predetermined vehicle part (a vehicle part that is an upgraded product) and the sticker.

For example, in the case where a product set of some vehicle part and a sticker was ordered in the past, second or later placement of order for the same sticker, and all the product sets including the sticker may be restricted.

Furthermore, in the case where the sticker was ordered by itself in the past, second or later placement of order for the same sticker, and all the product sets including the sticker may be restricted.

According to such a configuration, acquisition of a plurality of same stickers by placement of a plurality of orders may be prevented, and unintended circulation of the stickers may be prevented.

Furthermore, an information processing apparatus according to another mode of the present disclosure is an information processing apparatus for accepting an order for a product including a vehicle part, the information processing apparatus including a controller configured to determine, in relation to a target vehicle, whether to accept an order for a product at least including a sticker displaying that any of one or more of vehicle parts is upgraded, based on a record of upgrade of the predetermined vehicle part.

The record of upgrade is a record indicating that a predetermined vehicle part of a target vehicle was upgraded in the past. For example, the record of upgrade may be determined based on information acquired from a maintenance record database for vehicles.

In this manner, whether an order may be placed for a product including a sticker may also be determined based on the record of upgrade of a vehicle instead of on the record of order for a product.

Hereinafter, specific embodiments of the present disclosure will be described with reference to the drawings. Hardware configurations, module configurations, functional configurations and the like described in each embodiment are not intended to limit the technical scope of the disclosure thereto unless stated otherwise.

### First Embodiment

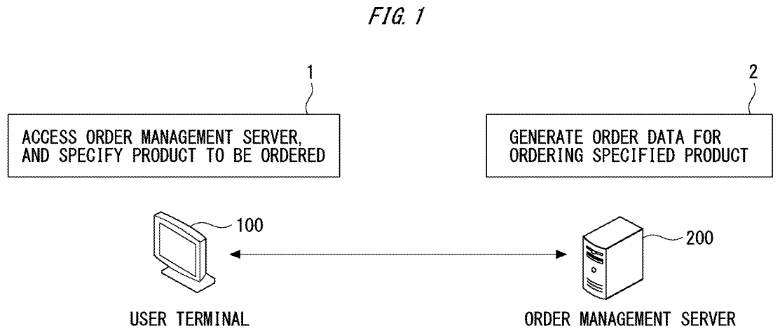

An outline of an order placement system according to a first embodiment will be described with reference to FIG. 1.

The order placement system according to the present embodiment includes a user terminal 100 that is associated with a user who orders a vehicle part, and an order management server 200 that accepts the order for the vehicle part.

The user terminal 100 is an information processing apparatus that is associated with a user who orders a vehicle part. The user terminal 100 may be a terminal owned by an end user (such as an owner of a vehicle), or may be a terminal installed at a sales office of a vehicle manufacturer or a repair site for vehicles.

Additionally, a vehicle part does not necessarily have to be a mechanical part or an electronic part as long as the vehicle part is an object used in a vehicle. For example, the vehicle parts include consumables used in a vehicle, a sticker displaying that any of vehicle part is upgraded, and the like.

In the present disclosure, a unit of order for a vehicle part will be referred to as “product”. The product may be a single vehicle part, or a set of a plurality of vehicle parts (for example, a set of a plurality of vehicle parts that are desirably supplied at the same time, or an assembly including a plurality of vehicle parts).

The order management server 200 is an information processing apparatus that accepts an order for a vehicle part that is to be supplied to a user. The order management server 200 accepts an order for a product from a user by interacting with the user terminal 100, and generates order data. The order data is transmitted to a site (such as a factory) where the vehicle part is manufactured or sold, and the vehicle part is thus supplied.

Now, the sticker in the present disclosure will be described. The sticker in the present disclosure is a label that is attached to a vehicle to certify that at least any of a plurality of vehicle parts of a vehicle is upgraded.

As a plurality of vehicle parts of a vehicle, an electronic control unit (ECU), an in-vehicle computer, a communication device, an infotainment terminal, an air conditioner, a seat, a steering wheel, a door, a sun roof, a mirror, and other electric components may be cited as examples. Additionally, in the description of the embodiment, the target of upgrade is a vehicle part, but the target of upgrade may instead be a component formed from a plurality of vehicle parts. In this case, a component may be upgraded by replacing the plurality of vehicle parts forming the component.

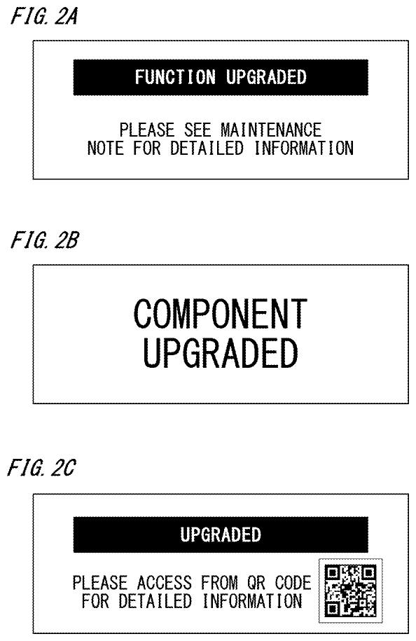

FIG. 2A to FIG. 2C are each a diagram illustrating an example of the sticker. Text displaying that a vehicle part is upgraded, and text displaying that a vehicle part is replaced with an upgraded product are written on the sticker. For example, a sticker denoted by FIG. 2A is a sticker displaying that a function is added to the vehicle. A sticker denoted by FIG. 2B is a sticker displaying that a component of the vehicle is upgraded. Furthermore, a sticker denoted by FIG. 2C is a sticker displaying that the vehicle is upgraded, and a two-dimensional code leading to a web site for checking details of the upgrade.

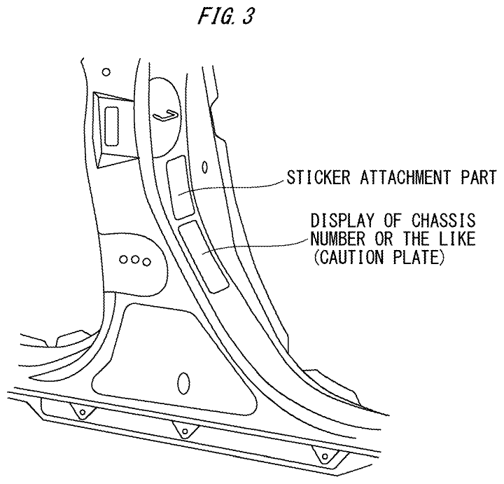

These stickers are attached to predetermined parts of the vehicle. FIG. 3 is a diagram describing a location where the sticker is to be attached. FIG. 3 is a diagram illustrating a vehicle body frame of the vehicle as seen from a front right side. A lower side in the drawing is a side sill, and a center is a center pillar (also referred to as a B pillar).

In the present example, the sticker is attached to a predetermined region disposed on the center pillar. The attachment part may be near a caution plate indicating a chassis number or the like. By disposing the sticker at such a part, whether upgrade is performed or not may be easily checked by opening a door.

Normally, such a sticker is supplied by the vehicle manufacturer as a type of vehicle part.

However, if an order for the sticker is accepted with no restriction, the sticker may be obtained even when a vehicle part is not upgraded. Furthermore, a sticker may be ordered even when the same sticker is already supplied.

A sticker obtained in such a manner is thus possibly attached to a vehicle, a vehicle part of which is not upgraded, to thereby, for example, increase value of the vehicle. When such a case occurs, the sticker itself is discredited.

Accordingly, the order management server 200 according to the present embodiment determines, in relation to a predetermined vehicle, whether to newly accept an order for a product including the sticker, based on whether there is a past record of order for a product including the sticker.

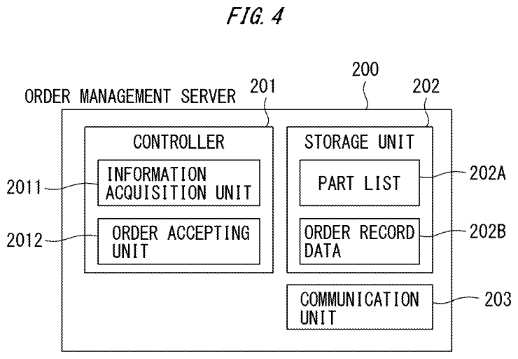

FIG. 4 is a diagram illustrating in detail structural elements of the order management server 200 included in the order placement system according to the present embodiment.

The order management server 200 generates order data for placing an order for a vehicle part, based on information acquired from the user terminal 100. Furthermore, the order management server 200 stores a database for managing a record of order for vehicle parts in relation to a plurality of vehicles being managed, and updates the database in the case where an order for a vehicle part is placed.

Moreover, in relation to a product including the sticker, the order management server 200 accepts an order for the product only in a case where a predetermined requirement is satisfied.

The order management server 200 may include a general-purpose computer. That is, the order management server 200 may be a computer that includes processors such as a CPU or a GPU, main memories such as a RAM or a ROM, and auxiliary memories such as an EPROM, a hard disk drive and a removable medium. The auxiliary memory stores an operating system (OS), various programs, various tables and the like, and each function matching a predetermined object as described below may be implemented by a program stored in the auxiliary memory being loaded in a work area of the main memory and executed and by each structural unit or the like being controlled through execution of the program. However, some or all of the functions may be implemented by a hardware circuit such as an ASIC or an FPGA.

In the present embodiment, the order management server 200 may be capable of implementing a Web server for interacting with the user terminal 100. In this case, the user terminal 100 may input/output information by accessing a Web service through a browser, for example. Additionally, the order management server 200 may provide services by means other than the Web server. For example, the order management server 200 may execute a service for interacting with dedicated application software installed in the user terminal 100 by a predetermined protocol.

The order management server 200 includes a controller 201, a storage unit 202, and a communication unit 203.

The controller 201 is an arithmetic device in charge of control that is performed by the order management server 200. The controller 201 may be implemented by an arithmetic processing device such as a CPU.

The controller 201 includes two functional modules, namely, an information acquisition unit 2011 and an order accepting unit 2012. Each functional module may be implemented by execution of a stored program by the CPU.

The information acquisition unit 2011 acquires data about an order for a vehicle part, by interacting with the user terminal 100. The information acquisition unit 2011 may generate a user interface screen for interacting with the user terminal 100. The user interface screen may be generated using a built-in web server or the like.

In the present embodiment, the information acquisition unit 2011 creates, based on an identifier of a vehicle received from the user terminal 100, a list of products including vehicle parts compatible with the vehicle, and provides the list. In the case where the sticker is included in a product, the information acquisition unit 2011 performs determination regarding order restrictions, and excludes a product not satisfying a predetermined condition from the list. Details of the process will be given later.

The order accepting unit 2012 accepts an order for a product specified by the user terminal 100. The order accepting unit 2012 generates data (order data) for placing an order for the specified product, based on data transmitted from the user terminal 100. The order data is transmitted to a site (a factory or the like) where the vehicle part is manufactured or sold.

The storage unit 202 includes a main memory and an auxiliary memory. The main memory is a memory where programs to be executed by the controller 201, and data to be used by the programs are developed. The auxiliary memory is a device where the programs to be executed by the controller 201, and the data to be used by the programs are stored.

Furthermore, the storage unit 202 stores a part list 202A and an order record data 202B.

The part list 202A is a database holding a list of vehicle parts that are compatible with a predetermined vehicle.

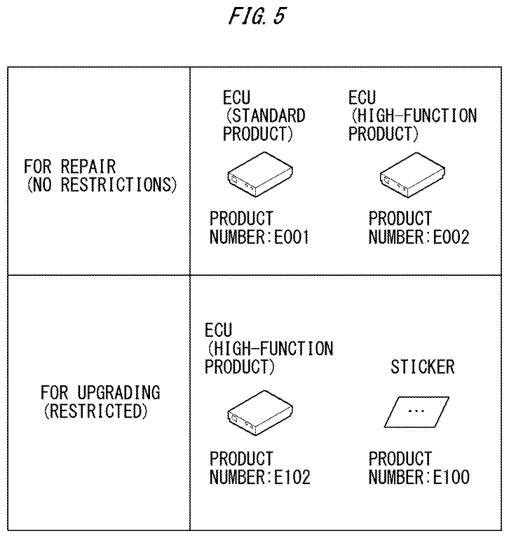

Now, a type of a product to be ordered (a product type) will be described by taking an electronic control unit (ECU) of a vehicle as an example. FIG. 5 is a diagram describing the product types. In the present example, two types, namely, a standard product and a high-function product, are prepared as the electronic control unit. The standard product is an electronic control unit that is installed in a vehicle as standard, and the high-function product is an electronic control unit including more functions than the standard product. A vehicle may be upgraded in an ex-post manner by replacing the standard product with the high-function product.

These electronic control units may each be ordered as a repair product. In the illustrated example, “product number: E001” is the standard repair product, and “product number: E002” is the high-function repair product.

In the present embodiment, a product for upgrading is separately provided. In the illustrated example, there is an electronic control unit (product number: E102) that is a product for upgrading. The electronic control unit for upgrading is a product same as the electronic control unit (product number: E002) for repair, but is supplied at a lower cost than the electronic control unit for repair. A product for upgrading is supplied for sole use of upgrading.

Such a product should not be ordered for purposes other than upgrading.

Accordingly, in the present embodiment, an order restriction is imposed on the product with the product number E102. That is, products with the product numbers E001, E002 may be ordered with no limitations, but the number of times of order placement is restricted for the product with the product number E102.

Furthermore, in the present embodiment, there is a sticker (product number: E100) as a product for upgrading. There is only one type (one product number) of sticker.

The end user may obtain an upgrade certificate by ordering the sticker, in a case where a given vehicle part is upgraded.

Only one sticker is to be attached to one vehicle. That is, the sticker should not be ordered multiple times.

Accordingly, in the present embodiment, an order restriction is imposed on a product whose product number is E100. More specifically, an order is allowed to be placed only once through life cycle of a vehicle.

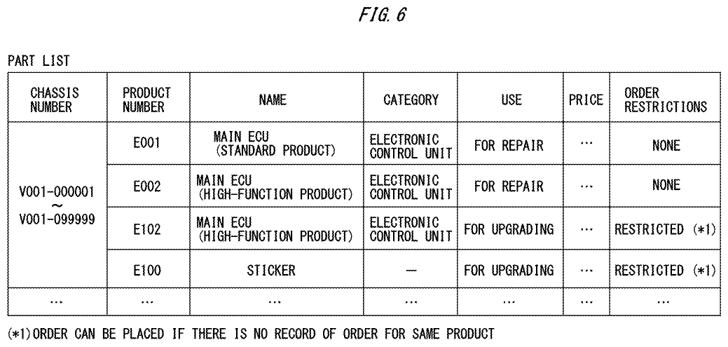

FIG. 6 is a list of vehicle parts described with reference to FIG. 5. The storage unit 102 stores such data as the part list 202A.

The part list 202A includes the following fields: chassis number, product number, name, category, use, price, and order restriction. An identifier for uniquely identifying a target vehicle is stored in the chassis number field. The chassis number is a combination of a model code and a serial number, for example. An identifier for uniquely identifying a product is stored in the product number field. The product number is different depending on whether the target product is a standard product or a high-function product. The product number is also different depending on whether the target product is supplied for repair or for upgrading. Additionally, the product number of a product that is compatible with a vehicle is different for each chassis number.

Data giving specifics of a vehicle part is stored in the name field.

A category of a corresponding product is stored in the category field. In the case where the product is only the sticker, the category is omitted.

Data identifying whether a corresponding product is supplied for repair or for upgrading is stored in the use field. A price of a corresponding product is stored in the price field.

Whether there is an order restriction regarding the product is stored in the order restriction field. In the present embodiment, in relation to a product for which “restricted” is indicated with regard to the order restriction, there is a restriction that “order may be placed only once” (in other words, an order may be placed only in the case where there is no past record of order for the same product). A specific method regarding order restriction will be described later.

By referring to the part list 202A, a list of products including vehicle parts that are compatible with a specified vehicle may be obtained.

Additionally, in the examples in FIGS. 5 and 6, there are two grades (the standard product and the high-function product) regarding a vehicle part, but there may be three or more grades regarding a vehicle part.

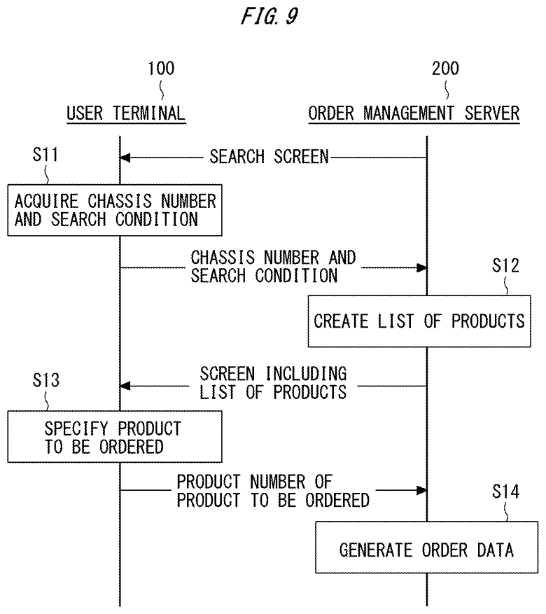

The order record data 202B is data recording a record of order for a vehicle part. FIG. 9A illustrates an example of the order record data 202B.

The order record data 202B includes the following fields: chassis number, product number, and date/time of order placement. The chassis number of a vehicle corresponding to an order is stored in the chassis number field. The product number of a product that is ordered is stored in the product number field. Data about date/time at which the order was placed is stored in the date/time of order placement field.

Each data piece described above may be constructed by managing data stored in a memory, by a program of a database management system (DBMS) executed by the processor. In this case, each data piece may be a relational database, for example.

The communication unit 203 is a communication interface for connecting the order management server 200 to a network. For example, the communication unit 203 includes a network interface board, or a wireless communication interface for wireless communication.

Next, a description will be given of the user terminal 100.

The user terminal 100 is a computer that is associated with an end user who orders a vehicle part. The end user (or a person receiving a request from the end user) may request placement of an order for a vehicle part by accessing the order management server 200 via the user terminal 100. The user terminal 100 is a personal computer, a smartphone, a mobile phone, a tablet computer, a personal digital assistant or the like, for example.

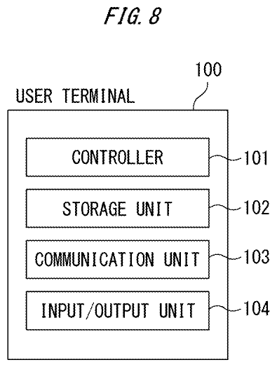

FIG. 8 is a diagram illustrating a system configuration of the user terminal 100.

The user terminal 100 includes a controller 101, a storage unit 102, a communication unit 103, and an input/output unit 104.

The controller 101 is an arithmetic device in charge of control that is performed by the user terminal 100. The controller 101 may be implemented by an arithmetic processing device such as a central processing unit (CPU).

The controller 101 executes a function of accessing the order management server 200, and interacting with the order management server 200. This function may be implemented by a web browser running on the user terminal 100, or by dedicated application software.

The storage unit 102 includes a main memory and an auxiliary memory. The main memory is a memory where programs to be executed by the controller 101, and data to be used by the programs are developed. The auxiliary memory is a device where the programs to be executed by the controller 101, and the data to be used by the programs are stored. Programs to be executed by the controller 101 may be packaged as applications and be stored in the auxiliary memory. Furthermore, an operating system for executing these applications may also be stored. Processes described below are performed by the programs stored in the auxiliary memory being loaded into the main memory and executed by the controller 101.

The main memory may include a random access memory (RAM) or a read only memory (ROM). Furthermore, the auxiliary memory may include an erasable programmable ROM (EPROM) or a hard disk drive (HDD). The auxiliary memory may further include a removable medium, or in other words, a removable recording medium.

The communication unit 103 is a wireless communication interface for connecting the user terminal 100 to a network. The communication unit 103 is capable of communicating with the order management server 200 via a wireless LAN or a mobile communication service such as 3G, LTE or 5G, for example.

The input/output unit 104 is a unit that receives an input operation performed by a user, and that presents information to the user. In the present embodiment, the input/output unit 104 includes one touch panel display, or in other words, a liquid crystal display and control means thereof, or a touch panel and control means thereof.

Additionally, the configurations illustrated in FIGS. 4 and 8 are merely examples, and all or some of the illustrated functions may be executed using an exclusively designed circuit. Furthermore, programs may be stored and executed by a combination of main memory and auxiliary memory other than those illustrated.

Next, details of processes performed by the apparatuses included in the order placement system will be given.

FIG. 9 is a sequence diagram illustrating processes that are performed by the user terminal 100 and the order management server 200. The processes illustrated in FIG. 9 are started by an action performed by a user on the user terminal 100 (for example, an access to the order placement system).

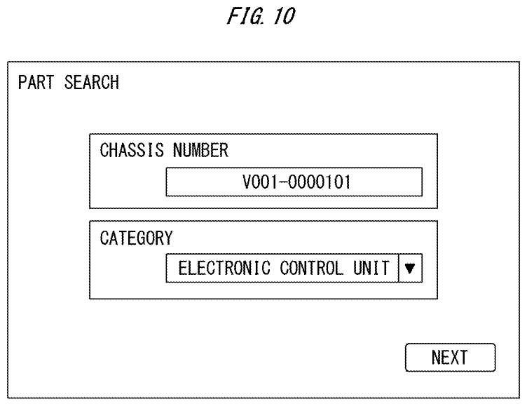

When the user terminal 100 accesses the order management server 200, the information acquisition unit 2011 generates a user interface screen including a search form, and provides the same to the user terminal 100. FIG. 10 is an example of the user interface screen including a search form. In the present example, a screen for specifying the chassis number and the category of the vehicle part is generated. The user terminal 100 makes the user input the chassis number and a search condition using the screen (step S11). The search condition may be the category or name of the vehicle part, for example. The chassis number and the search condition that are acquired are transmitted to the order management server 200.

In step S12, the order management server 200 (the information acquisition unit 2011) creates the list of products.

In the present step, the information acquisition unit 2011 searches for products corresponding to the specified chassis number, and creates the list by excluding products that cannot be ordered. Specifically, products satisfying the following conditions are excluded as targets.

(1) The order restriction in the part list 202A is “restricted”.
(2) The order record data 202B includes a past record of order for the corresponding product.

Sameness of a product may be determined based on the product number.

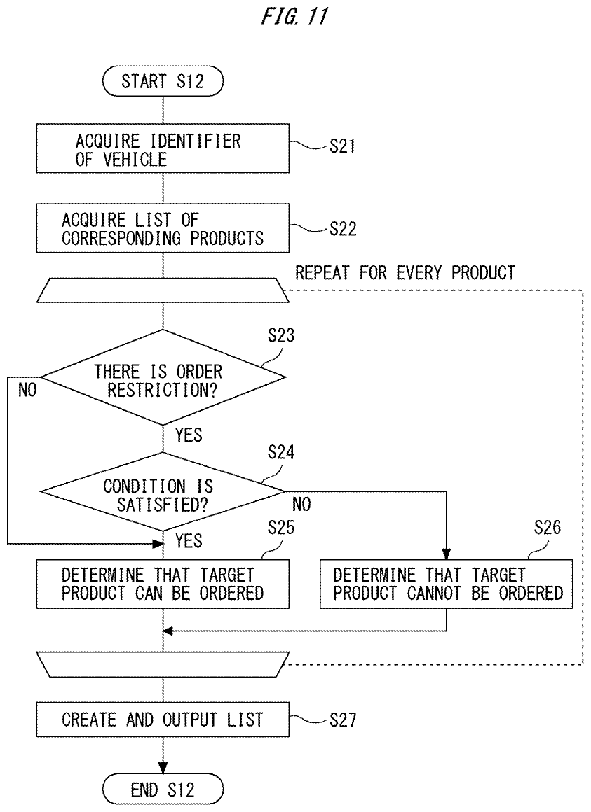

The processes that are performed in step S12 will be described in detail. FIG. 11 is a flowchart describing in detail the processes that are performed in step S12.

First, in step S21, an identifier (that is, the chassis number) of the vehicle is acquired. Next, in step S22, a list of products corresponding to the specified vehicle is acquired. In the present step, the list of corresponding products may be acquired by searching through the part list 202A with the chassis number as a key.

Processes of steps S23 to S26 are repeatedly performed for all the products that are acquired in step S22.

First, in step S23, whether the order restriction is imposed on the target product is determined. Whether the order restriction is imposed or not may be determined by searching through the part list 202A with the product number as a key. In the case where there is no order restriction on the target product, the process proceeds to step S25 and it is determined that the target part can be ordered. In the case where there is an order restriction on the target product, the process proceeds to step S24 and it is determined whether an order placement condition is satisfied or not.

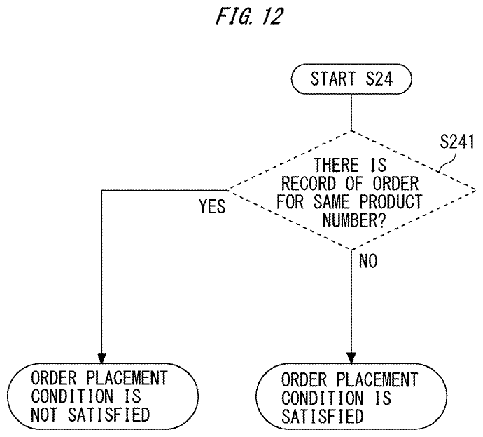

FIG. 12 is a flowchart describing a process that is performed in step S24.

In step S241, whether there is a past record of order for a product with the same product number is determined. Specifically, a search through the order record data 202B is performed with the chassis number and the product number as keys. In the case where a record is acquired as a result, it is determined that there is a past record of order for a product with the same product number. In this case, it is determined that the order placement condition is not satisfied. In the case where a record is not acquired, it is determined that there is no past record of order for a product with the same product number. In this case, it is determined that the order placement condition is satisfied.

In the case where it is determined in step S24 that the order placement condition is satisfied, the process proceeds to step S25 and it is determined that the target product can be ordered. In the case where it is determined in step S24 that the order placement condition is not satisfied, the process proceeds to step S26 and it is determined that the target product cannot be ordered.

By repeating the processes of steps S23 to S26, a plurality of products corresponding to the specified vehicle are categorized into products that can be ordered and products that cannot be ordered.

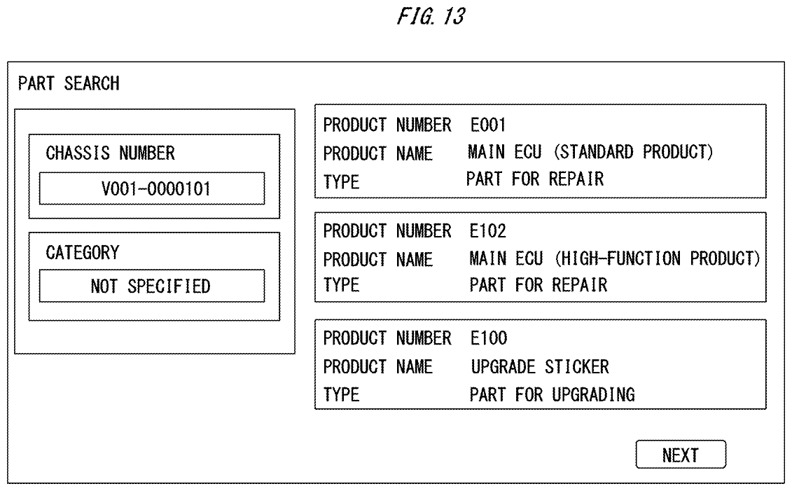

In step S27, a list of products that can be ordered is created using the categorization result. A screen as illustrated in FIG. 13 is thus generated, for example. Products that cannot be ordered are excluded from the screen.

Additionally, in the present step, a list including only the products that can be ordered may be created, or a list including all the products may be created. In this case, products that cannot be ordered may be made unselectable. Furthermore, a reason for being unselectable (for example, a notice indicating that there is a past record of order for a product of the same product number) may also be described.

Description will be resumed by returning to FIG. 9.

The screen including the list of products is provided to the user terminal 100, and a product to be ordered is specified by the user terminal 100 (step S13). When a product is specified, the corresponding product number is transmitted to the order management server 200 and is processed by the order accepting unit 2012. The order accepting unit 2012 generates the order data based on the product number that is acquired, and transmits the same to an external apparatus (step S14). The order accepting unit 2012 also adds a new record corresponding to a current order, to the order record data 202B.

As described above, in the first embodiment, an order restriction is imposed on a product including a sticker displaying that any of vehicle part of a vehicle is upgraded, and second or later placement of order is prevented. Accordingly, only one of same stickers may be supplied in relation to one vehicle, and unintended circulation of stickers may be prevented.

### Modification of First Embodiment

In the first embodiment, there is a problem that the sticker may be ordered even when a vehicle part is not ordered. To cope with such a situation, an order for the sticker may be accepted on a condition that a predetermined vehicle part is ordered at the same time. For example, in the case where the sticker is specified as a target of order in the processes in steps S13 and S14, whether another vehicle part that is for upgrading is specified at the same time as a target of order is determined, and the order may be rejected in the case where another vehicle part is not specified.

Additionally, this determination may be performed by the order management server 200, or by the user terminal 100. In the case of the former, an error may be returned to the user terminal 100 in the case where an order not satisfying the condition is placed. In the case of the latter, when an order not satisfying the condition is about to be placed (for example, when only the sticker is selected), placement of the order may be prevented by deactivating an order button, for example.

Additionally, placement of an order for only the sticker may be allowed on a condition that other means successfully confirms that any vehicle part of the target vehicle is already upgraded. For example, the order management server 200 may communicate with a database managing maintenance states of vehicles, and may check whether any vehicle part of the target vehicle is already upgraded or not. Additionally, even in such a case, determination about the order restriction described above is performed.

### Second Embodiment

As illustrated in FIG. 5, in the first embodiment, a vehicle part and the sticker are separately provided as products for upgrading. In contrast, a second embodiment is an embodiment in which a vehicle part for upgrading and the sticker corresponding to the vehicle part are supplied as a set.

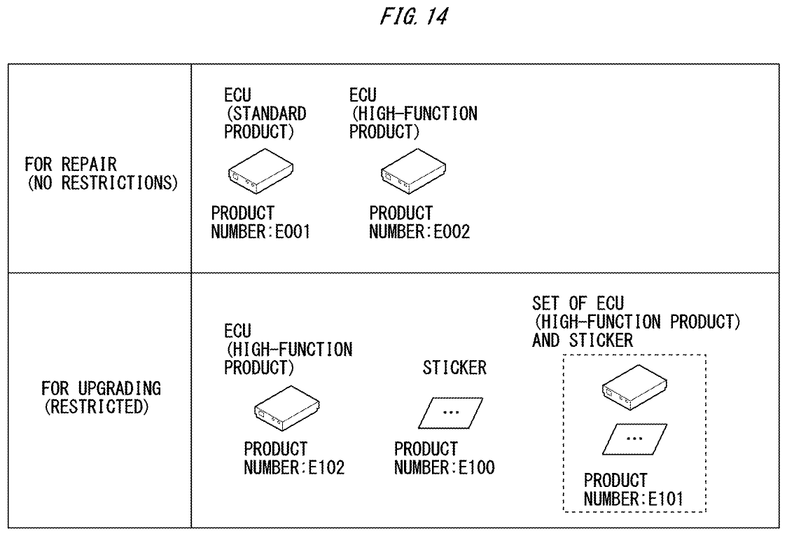

FIG. 14 is a diagram describing types of products that are supplied in the second embodiment. In the present embodiment, the following three are supplied as the products for upgrading.

(1) Only electronic control unit (product number: E102)
(2) Only sticker (product number: E100)
(3) A set of electronic control unit and sticker (product number: E101)

The end user may place an order by specifying any of the three as the product for upgrading.

In the present embodiment, a product that is a set of the electronic control unit and the sticker may be ordered. However, the following problem may occur in the case where the same order restriction as in the first embodiment is imposed.

That is, there is a problem that the sticker may be ordered by itself after an order is placed for the product set of the electronic control unit and the sticker, and vice versa. This is because the two have different product numbers (E100 and E101) and are not taken to be a same product.

To solve this problems, the following two types are defined in the second embodiment as types of order restrictions.

### (Type 1)

The first is “type where an order may be placed only once (type 1)”, as in the first embodiment. A product of type 1 can be ordered only when there is no record of order for the same product, as in the first embodiment.

### (Type 2)

The second is “type where an order may be placed when there is no past record of order for a product including the same sticker as the one included in the product (type 2)”. A product of type 2 may be only sticker and a product set including the vehicle part and the sticker, for example. This prevents “placement of an order for a product set including a vehicle part and a sticker after ordering the sticker by itself”, and vice versa. That is, a sticker may be prevented from being ordered multiple times.

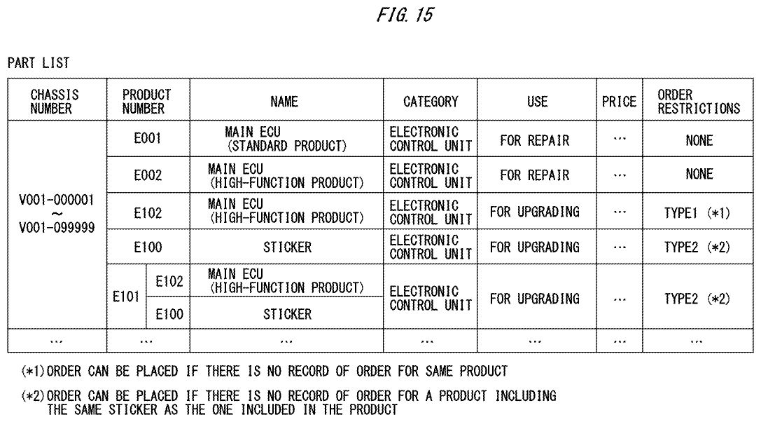

FIG. 15 is an example of the part list 202A reflecting the example described above.

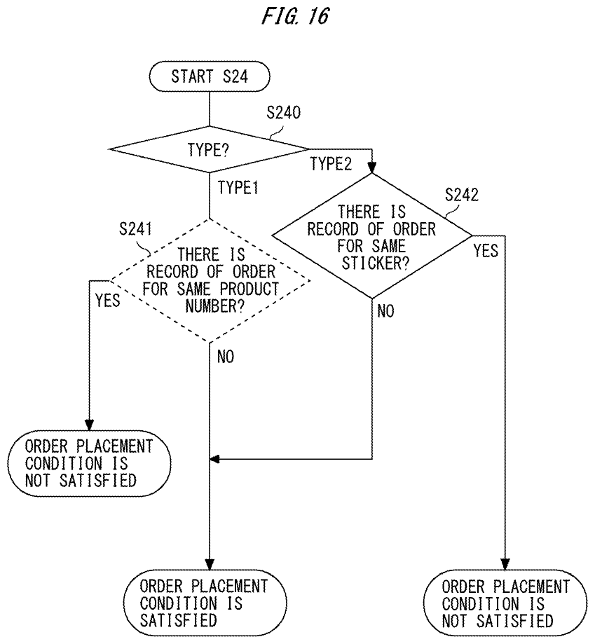

FIG. 16 is a flowchart of processes that are performed in step S24 in the second embodiment. A same process as the one in the first embodiment is indicated by a dotted line, and description thereof is omitted. Here, a description will be given assuming the products illustrated in FIG. 15 to be defined.

First, in step S240, the type of order restriction is determined for a target vehicle part. In the case where the type of order restriction is type 1, the process proceeds to step S241, and the same process as in the first embodiment is performed. In the case where the type of order restriction is type 2, the process proceeds to step S242.

In step S242, whether there is a record of order for a product including the same sticker as the one included in the product is determined. In the case of a positive determination in step S242, it is determined that the order placement condition is not satisfied. A positive determination here corresponds to a case where a product including a sticker was ordered in the past, and a product including the same sticker is being ordered.

In the case of a negative determination in step S242, it is determined that the order placement condition is satisfied. A negative determination here applies to a case where the target vehicle part (the electronic control unit) was ordered by itself in the past, and an order is being placed only for the sticker this time. In such a case, an order for the sticker is desirably accepted.

As described above, in the second embodiment, whether an order for a product can be placed or not is determined in relation to a target vehicle, by using a record of order for a product including the same sticker as the one included in the product. Accordingly, the sticker may be appropriately supplied even in a case where there is a product that is a set of a vehicle part and the sticker.

Modifications

The embodiments described above are merely examples, and the present disclosure may be changed as appropriate within the scope of the disclosure.

For example, the processes and means described in the present disclosure may be freely combined and practiced to the extent that no technical conflict exists.

In the description of the embodiments, whether an order for a product including the sticker can be placed or not is determined based on the past record of order for a product, but whether an order for a product including the sticker can be placed or not may also be determined based on a record of upgrade of the vehicle.

For example, in the case where there is a record of upgrade of a certain vehicle part of a target vehicle, an order for a product including the sticker may be allowed to be placed.

The record of upgrade may include a record of attachment of the sticker. For example, when there is a record of attachment of a sticker to a vehicle, placement of an order for a product including the same sticker may be restricted.

Furthermore, in the case where there is no record of upgrade of any vehicle part of a target vehicle, placement of an order for a product including only the sticker may be restricted.

The record of upgrade of a vehicle may be determined based on information that is acquired from a database managing a maintenance state of the vehicle, for example.

Furthermore, a process that is described to be performed by one apparatus may be shared and performed by a plurality of apparatuses. Alternatively, processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium includes any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions, for example.

What is claimed is:

1. An information processing apparatus for accepting an order for a product including a vehicle part, the information processing apparatus comprising:
a controller configured to determine, in relation to a target vehicle, whether to accept an order for a first product at least including a sticker displaying that any of one or more of vehicle parts is upgraded, based on a record of order for a product at least including the sticker.

2. The information processing apparatus according to claim 1, wherein, in relation to the target vehicle, the controller does not accept the order for the first product in a case where there is a past record of order for the product at least including the sticker.

3. The information processing apparatus according to claim 2, wherein, in relation to the target vehicle, the controller accept the order for the first product in a case where there is no past record of order for the product at least including the sticker, on a condition that a predetermined vehicle part is ordered at a same time.

4. The information processing apparatus according to claim 3, wherein the predetermined vehicle part is a vehicle part that is mounted to replace a lower-grade vehicle part.

5. The information processing apparatus according to claim 2, wherein, in relation to the target vehicle, the controller accepts the order for the first product in a case where there is no past record of order for the product at least including the sticker, on a condition that a predetermined vehicle part of the target vehicle is upgraded.

6. The information processing apparatus according to claim 1, wherein the sticker is a sticker that is attached to a vehicle body.

7. The information processing apparatus according to claim 1, wherein the controller acquires the record of order based on an identifier of the target vehicle specified by a user.

8. The information processing apparatus according to claim 1, wherein the controller creates a list of one or more of products being compatible with the target vehicle.

9. The information processing apparatus according to claim 8, wherein the controller creates the list by excluding the products for which placement of an order is determined not to be accepted.

10. The information processing apparatus according to claim 8, wherein the controller creates the list in which the products for which placement of an order is determined not to be accepted, is made unselectable.

11. An information processing method performed by a computer configured to accept an order for a product including a vehicle part, the information processing method comprising:
determining, in relation to a target vehicle, whether to accept an order for a first product at least including a sticker displaying that any of one or more of vehicle parts is upgraded, based on a record of order for a product at least including the sticker.

12. The information processing method according to claim 11, wherein
in relation to the target vehicle, the order for the first product is not accepted in a case where there is a past record of order for a product at least including the sticker.

13. The information processing method according to claim 12, wherein, in relation to the target vehicle, the order for the first product is accepted in a case where there is no past record of order for the product at least including the sticker, on a condition that a predetermined vehicle part is ordered at a same time.

14. The information processing method according to claim 13, wherein the predetermined vehicle part is a vehicle part that is mounted to replace a lower-grade vehicle part.

15. The information processing method according to claim 12, wherein, in relation to the target vehicle, the order for the first product is accepted in a case where there is no past record of order for the product at least including the sticker, on a condition that a predetermined vehicle part of the target vehicle is upgraded.

16. The information processing method according to claim 11, wherein the sticker is a sticker that is attached to a vehicle body.

17. The information processing method according to claim 11, wherein the record of order is acquired based on an identifier of the target vehicle specified by a user.

18. The information processing method according to claim 11, wherein a list of one or more of products being compatible with the target vehicle is created.

19. The information processing method according to claim 18, wherein the list is created by excluding the products for which placement of an order is determined not to be accepted.

20. An information processing apparatus for accepting an order for a product including a vehicle part, the information processing apparatus comprising:
a controller configured to determine, in relation to a target vehicle, whether to accept an order for a product at least including a sticker displaying that any of one or more of vehicle parts is upgraded, based on a record of upgrade of the predetermined vehicle part.
